(19) United States
(12) Patent Application Publication
(10) Pub. No.: US 2026/0278327 A1
(43) Pub. Date: Sep. 17, 2026

(54) VIDEO-BASED DEBUGGING AND SIMULATION SYSTEM FOR PROMPT IMPACT WITH LLM

(71) Applicant: Microsoft Technology Licensing, LLC, Redmond, WA (US)

(72) Inventors: Nishith ANAND, Noida (IN); Rahul Gupta, Gurugram (IN)

(21) Appl. No.: 19/076,706

(22) Filed: Mar. 11, 2025

(51) Int. Cl. G06N 3/04

(52) U.S. Cl. CPC G06N 3/04

(57) ABSTRACT

Techniques for visualizing and debugging how large language models (LLMs) process input prompts are described. A system generates a model blueprint comprising nodes that represent key properties and expertise areas of an LLM. Input prompts are tokenized and categorized into elements such as thoughts, actions, and examples, which are then mapped to corresponding nodes in the blueprint through an adapter component. A debugging console provides an interactive interface for visualizing information flow through the LLM nodes and enables real-time modification of prompts to observe impacts on token selection and model behavior. The system generates video output that captures the interaction of the prompt with model nodes and resulting changes, allowing users to analyze and optimize prompt engineering for more reliable results. This visualization system transforms prompt engineering from trial-and-error to a systematic approach by providing detailed insights into how LLMs interpret and process prompts.

### TECHNICAL FIELD

The present disclosure relates to systems and methods for visualizing and debugging the impact of input prompts on large language models (LLMs), and more particularly to video-based techniques for analyzing how input prompts are processed by LLM systems to generate output responses. The technical field specifically encompasses tools for prompt engineering that enable visualization of prompt token categorization, model blueprint node interactions, and the flow of information through LLM components to produce reliable prompt-based solutions.

### BACKGROUND

Recent advancements in artificial intelligence (AI) have led to the development of large language models (LLMs) capable of generating human-like text in response to user inputs. These models, trained on vast datasets, utilize deep learning techniques to predict and generate coherent text based on given prompts. LLMs have been widely adopted in various applications, including content generation, code development, customer support automation, and natural language understanding tasks.

The performance and utility of an LLM are significantly influenced by the quality and structure of its input prompt. A prompt serves as the primary mechanism by which users and developers communicate with the model, guiding its output toward a desired response. In addition to simple text inputs, prompts can include structured instructions, system directives, examples, constraints, and formatting preferences to refine the generated output. Developers and AI practitioners frequently engage in a process known as prompt engineering, which involves systematically crafting and refining prompts to achieve optimal model performance for a given task.

Prompt engineering has emerged as a critical aspect of working with LLMs, particularly in complex and high-stakes applications where the precision and reliability of the model's output are paramount. Developers iteratively modify prompts by altering wording, structuring inputs differently, and incorporating context-specific instructions to elicit more accurate, relevant, and contextually appropriate responses from the model. This process often involves testing variations of a prompt, evaluating outputs across multiple iterations, and adjusting parameters based on observed results.

As LLM capabilities have expanded, prompts themselves have become increasingly sophisticated. In many cases, prompts include detailed system instructions that define behavioral expectations, explicit user instructions, in-context examples that demonstrate ideal responses, and additional metadata to influence the model's response generation. The effectiveness of such prompts can vary across different LLM architectures, requiring developers to tailor their inputs to account for model-specific nuances, token limitations, and response tendencies.

Despite the advancements in prompt engineering, refining prompts to achieve a desired output remains a trial-and-error process. Developers must carefully analyze how changes to a prompt impact the model's response, often requiring extensive manual testing and iterative refinements. Additionally, different LLMs may interpret the same prompt in distinct ways due to variations in training data, model architecture, or system configurations, necessitating further adaptation of prompts for cross-model compatibility. This complexity underscores the importance of understanding the relationship between prompt structure and model behavior, as well as identifying techniques that can systematically guide prompt development and optimization.

### BRIEF DESCRIPTION OF THE DRAWINGS

Embodiments of the present invention are illustrated by way of example and not limitation in the figures of the accompanying drawings, in which:

FIG. 1 illustrates a system architecture for visualizing prompt processing in a large language model, showing components for prompt categorization, model blueprint rendering, and debugging visualization, consistent with some embodiments.

FIG. 2 illustrates a prompt analyzer console interface showing model selection, prompt input, blueprint visualization, and video generation controls, consistent with some embodiments.

FIG. 3 illustrates a flowchart showing a method for processing and visualizing prompt interactions with a large language model, consistent with some embodiments.

FIG. 4 illustrates a software architecture that may be installed on a machine for implementing the prompt visualization system, consistent with some embodiments.

FIG. 5 illustrates a diagrammatic representation of machine components and I/O interfaces that may be used to implement the prompt visualization system, consistent with some embodiments.

### DETAILED DESCRIPTION

Described herein are techniques for improving language model responses through automated prompt optimization and intelligent example selection. The methods and systems set forth herein enable precise control over prompt generation by using a multi-stage optimization process that combines automatically refined instructions with relevant historical examples. Rather than relying on static, manually-designed prompts that may provide suboptimal results, the disclosed approaches allow systems to dynamically generate and optimize prompts through iterative mutation and refinement operations while incorporating semantically similar examples retrieved through vector similarity search. The system combines optimized prompt instructions generated through controlled mutation operations with carefully selected historical examples and contextual information to improve response quality across various applications. In the following description, numerous specific details are provided, including techniques for prompt optimization, methods for similarity-based example retrieval, and approaches for combining optimized instructions with relevant context. These details enable one skilled in the art to practice the disclosed embodiments. It will be apparent, however, to one skilled in the art that the disclosed embodiments may be practiced without these specific details.

Beyond software developers, everyday users of LLM-powered applications face significant challenges when attempting to craft effective prompts. Business professionals using AI assistants for document analysis, students leveraging LLMs for research, and creative professionals employing AI tools for content generation all encounter the same fundamental technical problem-the inability to understand how their prompts are processed and interpreted by the underlying models.

For example, when a business analyst uses an LLM-powered chat interface to analyze market data, they may struggle to frame their prompts in a way that properly leverages the model's economics expertise. Similarly, when a content creator attempts to generate creative writing through an AI assistant, they have no visibility into how different components of their prompt-such as style instructions, plot elements, and character descriptions-are actually processed by the model's cognitive and creative capabilities.

The challenge extends to educational settings, where students and teachers using AI-powered learning tools need to carefully construct prompts to generate appropriate explanations and examples. Without proper visualization tools, these users resort to repeated trial-and-error attempts to achieve desired outcomes, unable to understand which aspects of their prompts are effectively engaging the model's knowledge nodes in subjects like physics, genetics, or other academic domains.

This lack of transparency affects anyone attempting to have meaningful interactions with LLM systems, from journalists crafting investigative queries to healthcare professionals seeking medical information analysis. The technical problem of prompt optimization impacts all users who need reliable, consistent results from their LLM interactions, regardless of their technical expertise or application domain.

The video-based debugging and simulation system includes an enhanced debugging console with model selection capabilities. Through a dropdown menu in the user interface, users can select specific LLM models and versions to test their prompts against, enabling comparison of prompt behavior across different model implementations.

The debugging console provides an interactive text editor where users can input and modify prompts in real-time. Users can execute the modified prompts against their selected model by clicking an “Execute” button, immediately visualizing how the changes affect the model's processing through the node interaction display.

A “Generate Video” button in the debugging console allows users to create an on-demand video visualization of the complete prompt processing flow. The generated video captures the entire sequence-from initial prompt tokenization, through categorization into elements like thoughts and actions, to the activation and interaction of model blueprint nodes representing different expertise areas and token selection criteria.

The video playback interface includes standard video controls (play, pause, rewind) allowing users to carefully analyze each step of the process. The video visualization shows how prompt tokens flow through and activate different nodes in the model blueprint, highlighting which model components (such as cognition, physics, or economics expertise nodes) are engaged by specific parts of the prompt. Users can observe in detail how modifications to thoughts, examples, actions, or grounded data in the prompt affect the pattern of node activation and ultimately influence the model's token selection and output generation.

Through this interactive console, users can systematically debug and optimize their prompts by directly observing how different prompt elements engage with the model's internal processing components. The video output provides a clear record of these interactions that can be reviewed, shared, and used to refine prompt engineering approaches. Other aspects and advantages of the various embodiments of the present invention will be apparent from the detailed descriptions of the several figures that follow.

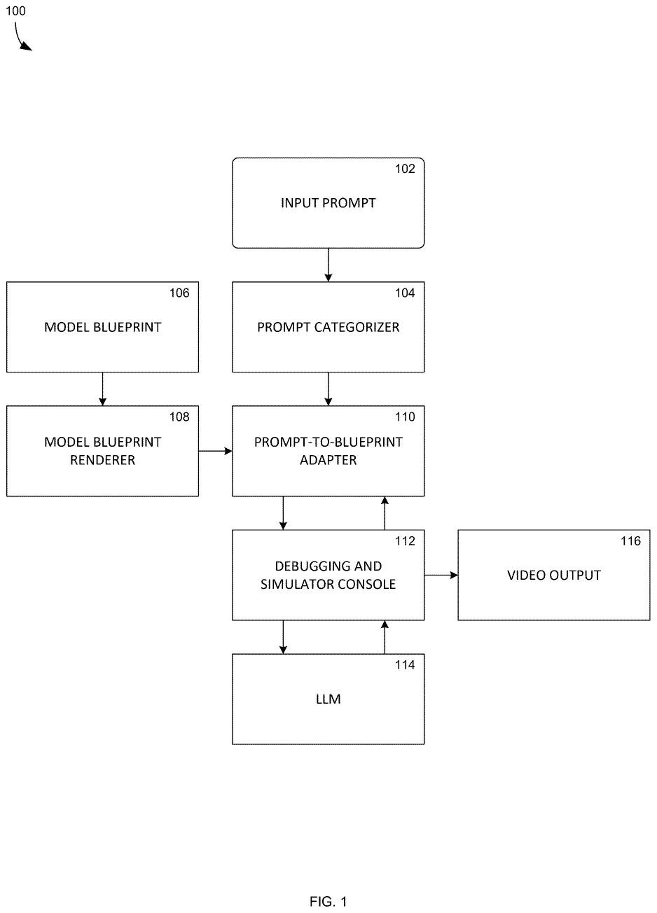

FIG. 1 illustrates a system architecture for visualizing prompt processing across different large language models, showing components for model selection, prompt categorization, blueprint rendering, and debugging visualization, consistent with some embodiments. Through the debugging console interface 112, users first select a specific LLM model and version from available options, which loads the corresponding model blueprint 106 containing the unique expertise areas and processing characteristics of that model. This model selection capability enables users to test how the same prompt performs across different models and versions-for example, comparing results between GPT-3.5 and GPT-4, or analyzing how prompt effectiveness changes as models are updated over time. The system maintains separate blueprints for each model version, allowing users to visualize how model updates affect prompt processing pathways and token selection criteria. By providing side-by-side comparisons of how prompts interact with different model architectures, the system helps users understand and optimize prompt performance across model versions and iterations. The debugging console enables real-time modification of prompts while preserving the visualization history, allowing users to track how prompt refinements impact different models and compare the evolution of model responses as underlying architectures are enhanced or modified.

The prompt categorizer 104 performs detailed analysis and categorization of the input prompt into distinct token types using the tokenization capabilities of the selected LLM model. After model selection via the debugging console interface, the categorizer interfaces with the selected model's tokenization component to break down the input prompt into its fundamental tokens. It then systematically processes these tokens to identify and classify elements including thoughts (e.g., cognitive reasoning), actions (e.g., behavioral instructions), examples (e.g., illustrative cases), grounded data (e.g., factual information), and point of view (e.g., perspective framing). For enterprise software prompts, this categorization becomes particularly sophisticated, handling multiple layers of instructions, context specifications, and output format requirements through the specific tokenization approach of the chosen model version.

The prompt categorizer analyzes input prompts using the selected model's tokenization capabilities to identify distinct categories of tokens. For example, in some embodiments, the categorizer may identify cognitive reasoning tokens as follows:

For cognitive reasoning elements (thoughts), the categorizer identifies tokens that establish expertise context and analytical frameworks. For example, in the prompt “You are an expert software engineer with deep knowledge of distributed systems. Analyze the following architecture diagram and provide detailed technical feedback,” the categorizer identifies “expert software engineer,” “deep knowledge,” and “analyze” as cognitive reasoning tokens that engage the model's technical analysis capabilities.

For behavioral instruction elements (actions), the categorizer recognizes command and specification tokens. For instance, in a prompt stating “Generate a PowerPoint presentation with the following specifications: Include 5 slides, use bullet points for key concepts,” the categorizer identifies “generate,” “include,” and “use” as action tokens that direct specific model behaviors.

For illustrative elements (examples), the categorizer detects template and format specification tokens. When processing “Here is an example of the desired output format: Title: Market Analysis Report Q4 2023,” the categorizer identifies the structural tokens that define the expected response format.

For grounded data elements, the categorizer identifies factual and statistical tokens. In a prompt containing “Using the following verified statistics: Revenue: $2.3M, Growth: 15% YoY,” the categorizer marks these quantitative data points as grounded information tokens.

For perspective framing elements, the categorizer recognizes viewpoint and priority tokens. When analyzing “Analyze this proposal from the perspective of a senior software architect who prioritizes system reliability,” the categorizer identifies tokens that establish the analytical lens and value framework.

The categorizer interfaces with the selected model's tokenization component to perform this classification, enabling the system to visualize how different prompt elements activate various model capabilities. This categorization becomes particularly sophisticated for complex enterprise software prompts that contain multiple layers of instructions, specifications, and requirements.

The model blueprint 106 maintains a comprehensive representation of the selected LLM's capabilities and processing characteristics. This includes an extensive network of nodes representing specialized knowledge domains, which may vary between different models and versions. While some models may include nodes for domains such as cognition, quantum physics, genetics, and economics, other models may contain nodes for different or additional domains based on their specific training and capabilities. The blueprint also contains nodes representing token selection criteria that determine how the model evaluates and processes different types of input based on context, style, and intended output format. The specific nodes and their relationships within the blueprint are determined by the unique characteristics and capabilities of each individual model, allowing the system to accurately represent how different models process and respond to prompts.

The model blueprint renderer 108 transforms the abstract model blueprint into a structured nodal visualization format through a multi-step process. First, it analyzes the low-level model characteristics to identify node types, including expertise domains and token selection criteria nodes. The renderer then creates a graph data structure where each node represents a model capability or processing component. For complex enterprise software prompts, the renderer generates additional layers of interconnected nodes to represent the multiple processing pathways. The renderer assigns visual attributes (e.g., size, color, connection weights) to nodes and edges based on their role and importance in the model's processing. This structured visualization enables clear tracking of how different prompt elements flow through and activate various parts of the model.

The prompt-to-blueprint adapter 110 implements sophisticated mapping algorithms to link categorized prompt tokens to specific blueprint nodes. The adapter first analyzes the semantic and functional relationships between prompt elements and model capabilities. For example, when processing a technical document, it uses natural language processing to identify domain-specific terminology and maps these to relevant expertise nodes. The adapter maintains a weighted graph showing how strongly different prompt components activate various model nodes. It tracks both direct relationships (e.g., technical terms mapping to domain expertise nodes) and indirect relationships (e.g., structural elements influencing token selection criteria). The adapter continuously updates these mappings as users modify prompts, enabling real-time visualization of how prompt changes affect node activation patterns and information flow through the model. This detailed mapping enables users to understand exactly how their prompt modifications influence the model's processing behavior and ultimate output generation.

The debugging and simulator console 112 provides an interactive interface with multiple specialized components. The console includes a model selection dropdown that allows users to choose between different LLM versions (e.g., GPT-3.5, GPT-4) and configurations. A prompt editing panel enables real-time modification of prompts with syntax highlighting for different token categories. The visualization panel displays an interactive node graph showing the model blueprint, with color-coded nodes representing different expertise domains and token selection criteria. Users can hover over nodes to see detailed information about their role and activation levels. The console provides split-screen views to compare prompt variations side-by-side and includes debugging controls like breakpoints and step-through capabilities for analyzing specific processing stages.

The LLM component 114 serves as the interface between the debugging system and the selected language model. When a user selects a specific model version, this component loads the corresponding model blueprint and tokenization rules. It processes prompts according to the model's specifications and provides detailed feedback on token processing, node activation, and output generation. The component maintains separate processing pipelines for different model versions, enabling users to compare how the same prompt is handled across multiple model implementations. It also tracks model updates and version changes to help users understand how prompt effectiveness evolves as models are enhanced.

The video output component 116 generates dynamic visualizations that capture the complete prompt processing sequence. The video begins by showing the initial prompt tokenization, with tokens color-coded by category (thoughts, actions, examples, etc.). It then animates the flow of these tokens through the model blueprint, showing how different prompt elements activate specific expertise and processing nodes. The visualization includes metrics showing node activation strengths and token selection probabilities. Interactive timeline controls allow users to pause, rewind, and step through the processing sequence. The component can generate side-by-side video comparisons showing how prompt modifications or model version changes affect processing patterns. Additional visualization layers can show token relationships, node dependencies, and impact analysis metrics.

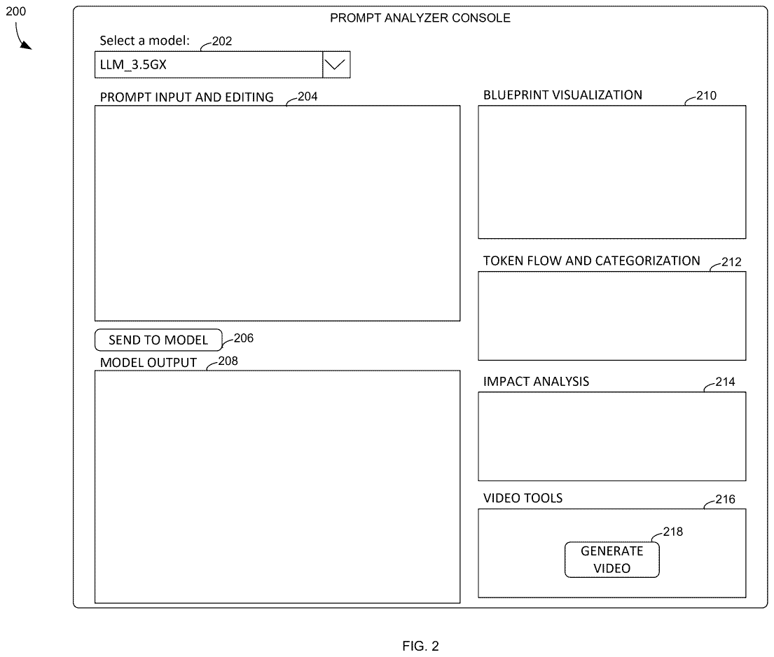

FIG. 2 illustrates a prompt analyzer console interface 200 showing model selection, prompt input, blueprint visualization, and video generation controls, consistent with some embodiments. The model selection dropdown 202 displays available LLM models and allows users to switch between different versions. When a user selects a model like LLM_3.5GX, the system loads the corresponding blueprint containing that model's unique expertise areas and processing characteristics.

The prompt input and editing area 204 provides a text editor with syntax highlighting that visually distinguishes different prompt elements. For example, when a user enters a prompt like “You are an expert software engineer with deep knowledge of distributed systems,” cognitive reasoning tokens appear highlighted in blue, while action tokens like “analyze” and “generate” are shown in green. The editor enables real-time modifications to test different prompt variations and immediately see their impact.

The blueprint visualization panel 210 displays an interactive node graph showing the model's expertise areas and processing components. As users modify prompts, the visualization updates to show how different nodes activate-for instance, when processing a technical document, the “Cognition” node might glow brighter as analytical tokens are processed, while domain-specific terminology activates nodes representing areas like physics or economics.

The token flow and categorization panel 212 provides a dynamic visualization of how prompt tokens move through the model's processing pipeline. Animated pathways show tokens flowing from input through categorization, with color-coding matching token categories and line thickness indicating connection weights between nodes.

The impact analysis panel 214 displays detailed metrics about the prompt-model interaction, including node activation percentages, token category distribution data, and processing pathway strength indicators. This helps users understand exactly how their prompt modifications affect different aspects of the model's behavior.

The video tools section 216 includes comprehensive playback controls for reviewing recorded visualization sequences. When users click the “Generate Video” button 218, the system captures the complete token flow animations, node activation patterns, and side-by-side comparisons of prompt variations, allowing detailed analysis of the entire prompt processing sequence.

The model output area 208 displays the final generated response, with visual highlighting that connects specific parts of the output back to the influential prompt components and activated nodes that produced them. This end-to-end visualization helps users understand exactly how their prompt choices influenced the model's processing and ultimate response.

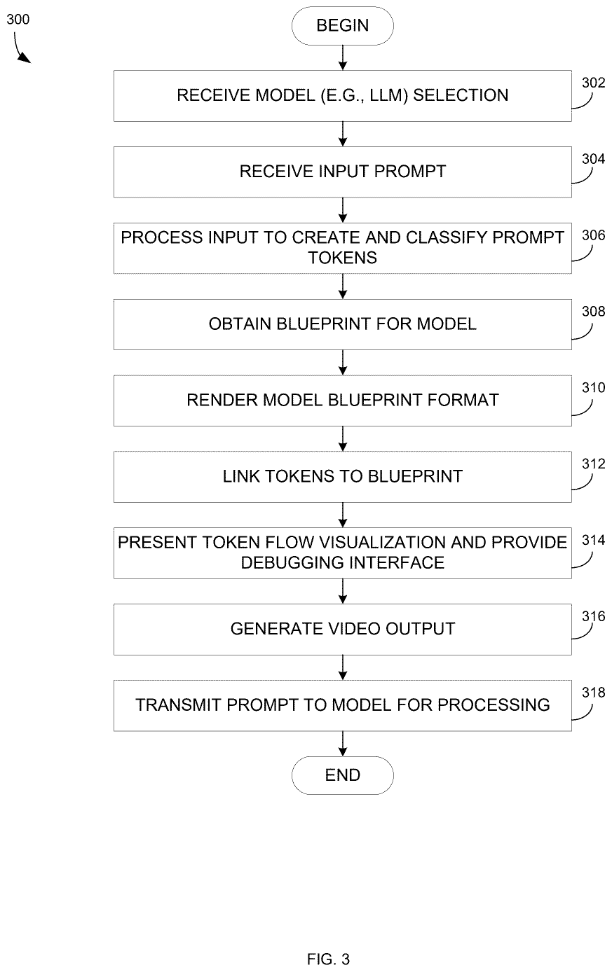

FIG. 3 illustrates a method for visualizing and analyzing prompt processing in a large language model, showing key steps from model selection through prompt execution, consistent with some embodiments.

The method begins with receiving a model selection 302, where a user selects a specific LLM model and version through the debugging console interface. This selection determines which model blueprint and tokenization capabilities will be used for processing the prompt.

After model selection, the system receives an input prompt 304 that will be analyzed. This prompt may range from simple queries to complex multi-page documents used in enterprise applications.

The process input step 306 involves using the selected model's tokenization capabilities to break down and classify the prompt tokens into categories including thoughts, actions, examples, and grounded data. For complex enterprise software prompts, this categorization handles multiple layers of instructions and specifications.

The obtain blueprint step 308 retrieves the comprehensive model blueprint containing nodes that represent the selected model's expertise areas and processing characteristics. This blueprint maps out how different types of tokens interact with the model's capabilities.

The render blueprint format step 310 transforms the abstract model blueprint into a structured nodal visualization format. This includes converting low-level model characteristics into an organized data structure that enables clear visualization of processing pathways.

The link tokens step 312 establishes mappings between the categorized prompt tokens and corresponding blueprint nodes using sophisticated algorithms. This creates traceable connections showing how each prompt element activates and interacts with specific model capabilities.

The present visualization step 314 provides an interactive debugging interface where users can observe token flow through model nodes and modify prompts to see how changes affect processing. This includes features for analyzing node activation patterns and impact assessment.

The generate video output step 316 creates detailed visualizations of the complete prompt processing sequence, showing token flow, node activation patterns, and processing pathways through animated and color-coded representations.

Finally, the transmit prompt step 318 sends the prompt to the selected model for actual processing, allowing users to compare the visualized predictions with actual model behavior.

The video-based debugging and simulation system provides significant technical improvements over conventional prompt engineering approaches. By transforming the previously opaque process of prompt-model interaction into a transparent, analyzable system, the technology enables precise understanding and optimization of how prompts influence large language model outputs.

A key technical advantage is the system's ability to visually map and analyze the complex relationships between prompt components and model processing nodes. Rather than relying on trial-and-error experimentation, users can directly observe how different prompt elements activate specific model capabilities through the interactive debugging console. This visualization capability dramatically improves prompt optimization efficiency compared to traditional approaches where developers must blindly modify prompts without insight into their impact.

The system's model blueprint visualization and token flow analysis provides unprecedented visibility into how prompts are processed. Users can trace exactly how prompt modifications affect node activation patterns and information flow, enabling systematic refinement rather than speculative changes. This represents a fundamental improvement over conventional methods where prompt engineering relies primarily on output observation without understanding the underlying processing.

The technology also addresses the critical challenge of maintaining prompt reliability across model updates. By providing detailed visualizations of how prompts interact with different model versions, the system enables users to quickly identify and address compatibility issues as models evolve. This capability eliminates much of the manual re-validation work previously required when models are updated.

The video output generation feature transforms complex prompt-model interactions into clear, shareable visualizations that can be analyzed and refined over time. This enables collaborative prompt optimization and knowledge sharing that was impossible with traditional approaches. The system's comprehensive debugging capabilities, from real-time token flow visualization to impact analysis metrics, provide the technical foundation for transforming prompt engineering from an art into a systematic engineering discipline.

### MACHINE AND SOFTWARE ARCHITECTURE

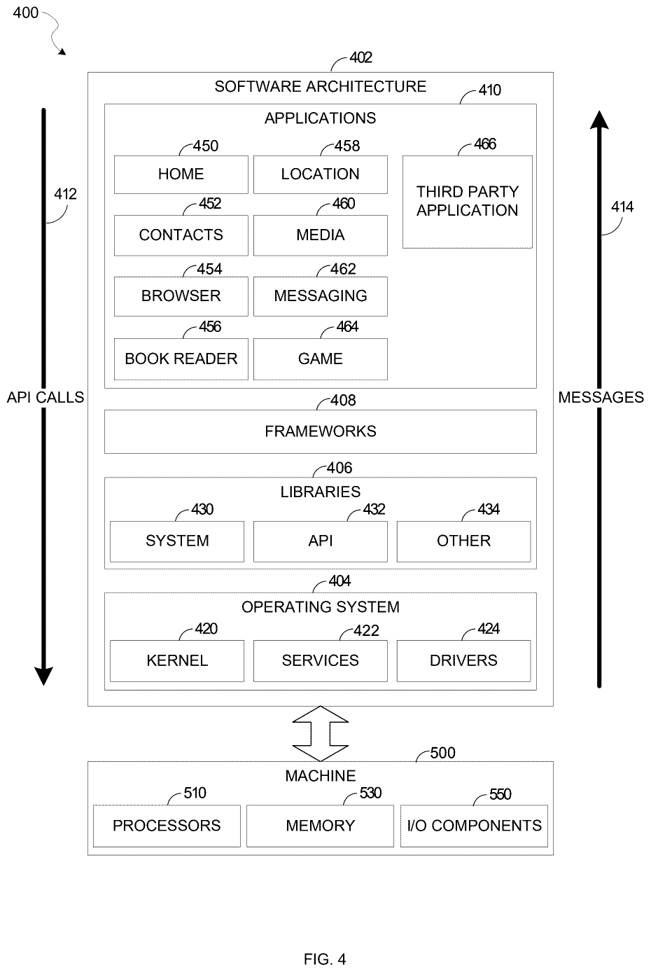

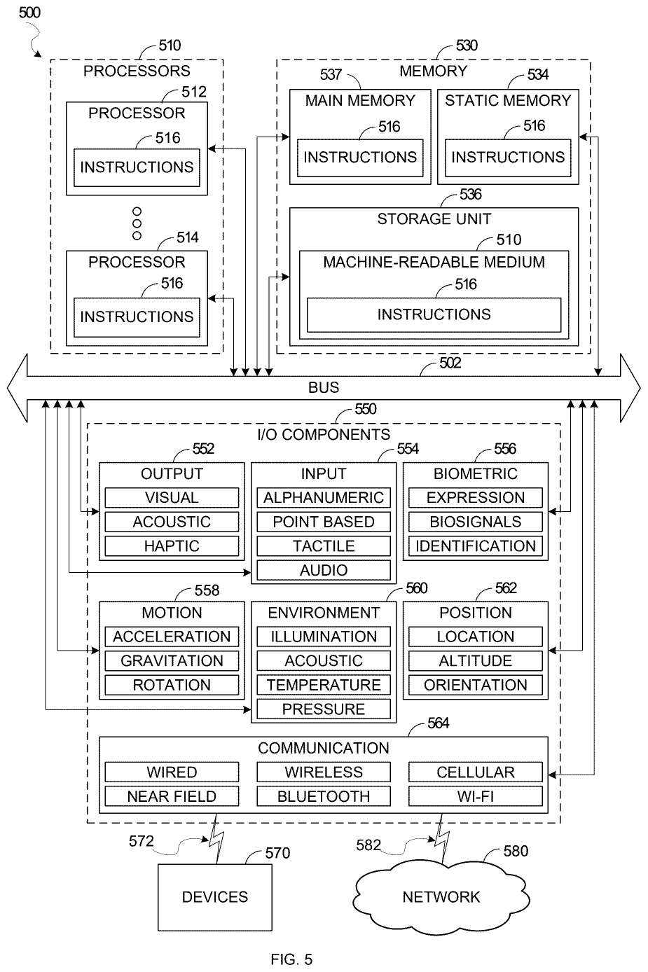

FIG. 4 is a block diagram 400 illustrating a software architecture 402, which can be installed on any of a variety of computing devices to perform methods consistent with those described herein. FIG. 4 is merely a non-limiting example of a software architecture, and it will be appreciated that many other architectures can be implemented to facilitate the functionality described herein. In various embodiments, the software architecture 402 is implemented by hardware such as a machine 500 of FIG. 5 that includes processors 510, memory 530, and input/output (I/O) components 550. In this example architecture, the software architecture 402 can be conceptualized as a stack of layers where each layer may provide a particular functionality. For example, the software architecture 402 includes layers such as an operating system 404, libraries 406, frameworks 408, and applications 410. Operationally, the applications 410 invoke API calls 412 through the software stack and receive messages 414 in response to the API calls 412, consistent with some embodiments.

In various embodiments, the operating system 404 manages hardware resources and provides common services. The operating system 404 includes, for example, a kernel 420, services 422, and drivers 424. The kernel 420 acts as an abstraction layer between the hardware and the other software layers, consistent with some embodiments. For example, the kernel 420 provides memory management, processor management (e.g., scheduling), component management, networking, and security settings, among other functionality. The services 422 can provide other common services for the other software layers. The drivers 424 are responsible for controlling or interfacing with the underlying hardware, according to some embodiments. For instance, the drivers 424 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 406 provide a low-level common infrastructure utilized by the applications 410. The libraries 406 can include system libraries 430 (e.g., C standard library) that can provide functions such as memory allocation functions, string manipulation functions, mathematic functions, and the like. In addition, the libraries 406 can include API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 406 can also include a wide variety of other libraries 434 to provide many other APIs to the applications 410.

The frameworks 408 provide a high-level common infrastructure that can be utilized by the applications 410, according to some embodiments. For example, the frameworks 408 provide various GUI functions, high-level resource management, high-level location services, and so forth. The frameworks 408 can provide a broad spectrum of other APIs that can be utilized by the applications 410, some of which may be specific to a particular operating system 404 or platform.

In an example embodiment, the applications 410 include a home application 450, a contacts application 452, a browser application 454, a book reader application 456, a location application 458, a media application 460, a messaging application 462, a game application 464, and a broad assortment of other applications, such as a third-party application 466. According to some embodiments, the applications 410 are programs that execute functions defined in the programs. Various programming languages can be employed to create one or more of the applications 410, structured in a variety of manners, such as object-oriented programming languages (e.g., Objective-C, Java, or C++) or procedural programming languages (e.g., C or assembly language). In a specific example, the third-party application 466 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 466 can invoke the API calls 412 provided by the operating system 404 to facilitate functionality described herein.

FIG. 5 illustrates a diagrammatic representation of a machine 500 in the form of a computer system within which a set of instructions may be executed for causing the machine to perform any one or more of the methodologies discussed herein, according to an example embodiment. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. For example the instructions 516 may cause the machine 500 to execute any one of the methods or algorithmic techniques described herein. Additionally, or alternatively, the instructions 516 may implement any one of the systems described herein. The instructions 516 transform the general, non-programmed machine 500 into a particular machine 500 programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory 530, and I/O components 550, which may be configured to communicate with each other such as via a bus 502. In an example embodiment, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 512 and a processor 514 that may execute the instructions 516. The term “processor” is intended to include multi-core processors that may comprise two or more independent processors (sometimes referred to as “cores”) that may execute instructions contemporaneously. Although FIG. 5 shows multiple processors 510, the machine 500 may include a single processor with a single core, a single processor with multiple cores (e.g., a multi-core processor), multiple processors with a single core, multiple processors with multiples cores, or any combination thereof.

The memory 530 may include a main memory 532, a static memory 534, and a storage unit 536, all accessible to the processors 510 such as via the bus 502. The main memory 530, the static memory 534, and storage unit 536 store the instructions 516 embodying any one or more of the methodologies or functions described herein. The instructions 516 may also reside, completely or partially, within the main memory 532, within the static memory 534, within the storage unit 536, within at least one of the processors 510 (e.g., within the processor's cache memory), or any suitable combination thereof, during execution thereof by the machine 500.

The I/O components 550 may include a wide variety of components to receive input, provide output, produce output, transmit information, exchange information, capture measurements, and so on. The specific I/O components 550 that are included in a particular machine will depend on the type of machine. For example, portable machines such as mobile devices will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion and the grouping is in no way limiting. In various example embodiments, the I/O components 550 may include output components 552 and input components 554. The output components 552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 550 may include biometric components 556, motion components 558, environmental components 560, or position components 562, among a wide array of other components. For example, the biometric components 556 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 562 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 550 may include communication components 564 operable to couple the machine 500 to a network 580 or devices 570 via a coupling 582 and a coupling 572, respectively. For example, the communication components 564 may include a network interface component or another suitable device to interface with the network 580. In further examples, the communication components 564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., a peripheral device coupled via a USB).

Moreover, the communication components 564 may detect identifiers or include components operable to detect identifiers. For example, the communication components 564 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 564, such as location via Internet Protocol (IP) geolocation, location via Wi-Fi® signal triangulation, location via detecting an NFC beacon signal that may indicate a particular location, and so forth.

### EXECUTABLE INSTRUCTIONS AND MACHINE STORAGE MEDIUM

The various memories (i.e., 530, 532, 534, and/or memory of the processor(s) 510) and/or storage unit 536 may store one or more sets of instructions and data structures (e.g., software) embodying or utilized by any one or more of the methodologies or functions described herein. These instructions (e.g., the instructions 516), when executed by processor(s) 510, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### TRANSMISSION MEDIUM

In various example embodiments, one or more portions of the network 580 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 580 or a portion of the network 580 may include a wireless or cellular network, and the coupling 582 may be a Code Division Multiple Access (CDMA) connection, a Global System for Mobile communications (GSM) connection, or another type of cellular or wireless coupling. In this example, the coupling 582 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 516 may be transmitted or received over the network 580 using a transmission medium via a network interface device (e.g., a network interface component included in the communication components 564) and utilizing any one of a number of well-known transfer protocols (e.g., HTTP). Similarly, the instructions 516 may be transmitted or received using a transmission medium via the coupling 572 (e.g., a peer-to-peer coupling) to the devices 570. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 516 for execution by the machine 500, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### COMPUTER-READABLE MEDIUM

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one processor; and
at least one memory storage device storing instructions thereon, which, when executed by the at least one processor, cause the system to perform operations comprising:
receiving an input prompt for a large language model (LLM);
generating a model blueprint comprising nodes representing properties of the LLM that impact results generated by the LLM, wherein the nodes include expertise areas and token selection criteria of the LLM;
categorizing tokens of the input prompt into categories comprising thoughts, actions, examples, and grounded data;
rendering the model blueprint into a nodal format;
generating, via a prompt-to-blueprint adapter, linkages between the categorized prompt tokens and corresponding nodes in the rendered model blueprint;
providing a debugging console interface that:
displays a visualization of information flow through the nodes of the LLM based on the generated linkages,
enables modification of the input prompt to observe changes in node interactions, and
displays impacts of the modifications on token nodes and category nodes of the model; and
generating a video output representing the impact of the input prompt on the LLM model, wherein the video output visualizes the information flow through the LLM nodes and resulting token selections.

2. The system of claim 1, wherein the model blueprint comprises nodes representing expertise areas including cognition, quantum physics, genetics, and economics.

3. The system of claim 1, wherein categorizing the tokens of the input prompt comprises categorizing the tokens into at least one of: thoughts, actions, examples, point of view, and grounded data.

4. The system of claim 1, wherein the debugging console interface enables real-time modification of the input prompt to visualize changes in node interactions when modifying at least one of: thoughts, examples, actions, point of view, and grounded data.

5. The system of claim 1, wherein the nodes of the model blueprint further comprise token selection criteria nodes that determine how the LLM selects tokens based on relationships with the input prompt.

6. The system of claim 1, wherein the prompt-to-blueprint adapter implements an algorithm for linking prompt tokens to blueprint nodes and representing impact measurements of the prompt on various nodes in the LLM model.

7. The system of claim 1, wherein the video output provides an on-demand visualization of the information flow from the input prompt through the LLM nodes to generate final output tokens.

8. The system of claim 1, wherein the operations further comprise converting the model blueprint into a nodal format via a blueprint renderer for consumption by the prompt-to-blueprint adapter.

9. A method for visualizing prompt processing in a large language model (LLM), the method comprising:
receiving an input prompt for a large language model (LLM);
generating a model blueprint comprising nodes representing properties of the LLM that impact results generated by the LLM, wherein the nodes include expertise areas and token selection criteria of the LLM;
categorizing tokens of the input prompt into categories comprising thoughts, actions, examples, and grounded data;
rendering the model blueprint into a nodal format;
generating, via a prompt-to-blueprint adapter, linkages between the categorized prompt tokens and corresponding nodes in the rendered model blueprint;
providing a debugging console interface that:
displays a visualization of information flow through the nodes of the LLM based on the generated linkages,
enables modification of the input prompt to observe changes in node interactions, and
displays impacts of the modifications on token nodes and category nodes of the model; and
generating a video output representing the impact of the input prompt on the LLM model, wherein the video output visualizes the information flow through the LLM nodes and resulting token selections.

10. The method of claim 9, wherein the model blueprint comprises nodes representing expertise areas including cognition, quantum physics, genetics, and economics.

11. The method of claim 9, wherein categorizing the tokens of the input prompt comprises categorizing the tokens into at least one of: thoughts, actions, examples, point of view, and grounded data.

12. The method of claim 9, wherein the debugging console interface enables real-time modification of the input prompt to visualize changes in node interactions when modifying at least one of: thoughts, examples, actions, point of view, and grounded data.

13. The method of claim 9, wherein the nodes of the model blueprint further comprise token selection criteria nodes that determine how the LLM selects tokens based on relationships with the input prompt.

14. The method of claim 9, wherein the prompt-to-blueprint adapter implements an algorithm for linking prompt tokens to blueprint nodes and representing impact measurements of the prompt on various nodes in the LLM model.

15. The method of claim 9, wherein the video output provides an on-demand visualization of the information flow from the input prompt through the LLM nodes to generate final output tokens.

16. The method of claim 9, further comprising converting the model blueprint into a nodal format via a blueprint renderer for consumption by the prompt-to-blueprint adapter.

17. A computer-readable storage medium having computer-executable instructions stored thereupon which, when executed by one or more processors of a computing device, cause the computing device to:
receive an input prompt for a large language model (LLM);
generate a model blueprint comprising nodes representing properties of the LLM that impact results generated by the LLM, wherein the nodes include expertise areas and token selection criteria of the LLM;
categorize tokens of the input prompt into categories comprising thoughts, actions, examples, and grounded data;
render the model blueprint into a nodal format;
generate, via a prompt-to-blueprint adapter, linkages between the categorized prompt tokens and corresponding nodes in the rendered model blueprint;
provide a debugging console interface that:
displays a visualization of information flow through the nodes of the LLM based on the generated linkages,
enables modification of the input prompt to observe changes in node interactions, and
displays impacts of the modifications on token nodes and category nodes of the model; and
generate a video output representing the impact of the input prompt on the LLM model, wherein the video output visualizes the information flow through the LLM nodes and resulting token selections.

18. The computer-readable storage medium of claim 17, wherein the model blueprint comprises nodes representing expertise areas including cognition, quantum physics, genetics, and economics.

19. The computer-readable storage medium of claim 17, wherein categorizing the tokens of the input prompt comprises categorizing the tokens into at least one of: thoughts, actions, examples, point of view, and grounded data.

20. The computer-readable storage medium of claim 17, wherein the debugging console interface enables real-time modification of the input prompt to visualize changes in node interactions when modifying at least one of: thoughts, examples, actions, point of view, and grounded data.
